(19) United States
(12) Patent Application Publication
(10) Pub. No.: US 2010/0212980 A1
(43) Pub. Date: Aug. 26, 2010

(54) POWER WHEEL

(76) Inventor: Hua Wang, Beijing (CN)

Correspondence Address: KNOBBE MARTENS OLSON & BEAR LLP, 2040 MAIN STREET, FOURTEENTH FLOOR, IRVINE, CA, 92614, US

(21) Appl. No.: 12/775,248

(22) Filed: May 6, 2010

Related U.S. Application Data
(63) Continuation of application No. PCT/CN2008/072967, filed on Nov. 6, 2008.

(30) Foreign Application Priority Data
Nov. 7, 2007 (CN) 200710176948.2

(51) Int. Cl. B62M 7/12; B60R 16/04

(52) U.S. Cl. 180/65.51; 318/139

(57) ABSTRACT

A power wheel is provided. The power wheel includes a wheel, a power-driving device, and a power supply for the power-driving device. The power supply and the power-driving device are fixed on the wheel. A power supply device such as a rechargeable battery is set in the wheel to fully utilize the space in the wheel. The power wheel is applicable in an electric bicycle, so that a body design of the electric bicycle is not influenced by mounting conditions of the rechargeable battery device, and a body structure of the electric bicycle is greatly simplified, thus being beneficial to the design and production of electric bicycles having varied types. At the same time, the power wheel device having the rechargeable battery set in the wheel enables the gravity center of the electric bicycle to be depressed, thus keeping the balance of the electric bicycle.

### CROSS-REFERENCE TO RELATED APPLICATIONS

This application is a continuation of International Application No. PCT/CN2008/072967, filed on Nov. 6, 2008, which in turn claims the priority benefits of Chinese Patent Application No. 200710176948.2, filed on Nov. 7, 2007. The contents of the above prior applications are herein incorporated by reference in their entireties.

### BACKGROUND OF THE INVENTION

1. Field of the Invention

The present invention relates to a power wheel, and more particularly to a power wheel provided with a power supply and a power-driving device.

2. Background

Currently, for an electric bicycle available in the market, a rechargeable battery device is mainly placed at a position of a frame's down tube or seat tube, or fixed between a front wheel and a handlebar, or fixed at a rear side of the seat post. However, as when a type of electric bicycle is designed, mounting conditions of the rechargeable battery device have to be considered, and the rechargeable battery occupies a large space in the body, therefore the type of electric bicycle becomes bulky, portability of the electric bicycle is difficult to be realized, and the technical difficulty of realizing foldability of the electric bicycle is increased. Furthermore, as the rechargeable battery case body and the integral electric bicycle make an unattractive appearance, an appearance design of the electric bicycle is greatly constrained by the conditions of the rechargeable battery device, resulting in a single type, so that design and production of varied electric bicycle types are limited.

### SUMMARY OF THE INVENTION

The present invention is directed to a power wheel provided with a power supply and a power-driving device, and the power wheel is applicable in an electric bicycle, so as to effectively overcome the defects in the prior art that an exterior design of the electric bicycle is constrained by the conditions of the power supply device.

Accordingly, the present invention provides a power wheel, which includes a wheel, a power-driving device for driving the wheel to rotate, and a power supply for supplying power for the power-driving device. The power supply and the power-driving device are fixed on the wheel.

In the technical solution above, the power supply may be a rechargeable battery. The power-driving device may be a motor. The wheel may include a fixed portion formed of a wheel spindle and members connected to the wheel spindle, and a rotating portion connected with a shell body of the motor. The rechargeable battery is connected to the motor.

In the technical solution above, the rechargeable battery is fixed at the fixed portion of the wheel and connected with the motor through a conductive slip ring or a connecting line. The rechargeable battery is fixed at one side or two sides of the wheel spindle. Furthermore, the fixed portion may include a battery case fixed at one side or two sides of the wheel spindle. The rechargeable battery is fixed in the battery case.

In the technical solution above, the rotating portion includes an outer ring of the wheel and spokes connected between the outer ring and the shell body of the motor. The rechargeable battery is fixed among the spokes. A battery box may be further fixed among the spokes. The rechargeable battery is fixed inside the battery box and connected with the motor through a connecting line or a conductive slip ring.

In the technical solution above, the rotating portion may further include an outer ring of the wheel. The rechargeable battery is set between the outer ring of the wheel and the shell body of the motor. A battery box may be further set between the outer ring of the wheel and the shell body of the motor. The rechargeable battery is fixed inside the battery box and connected with the motor through a connecting line or a conductive slip ring.

The present invention fully utilizes the space of the wheel, and the power supply device such as the rechargeable battery is set in the wheel, so as to provide a power wheel applicable in an electric bicycle. Therefore, a body design of the electric bicycle is not influenced by mounting conditions of the rechargeable battery device, the body structure of the electric bicycle is greatly simplified, thus facilitating the design and production of electric bicycles having varied types. At the same time, the power wheel device having the rechargeable battery set in the wheel enables the gravity center of the electric bicycle to be depressed, thus keeping the balance of the electric bicycle.

### BRIEF DESCRIPTION OF THE DRAWINGS

FIG. 1 is a schematic structural view of a power wheel according to a first embodiment of the present invention;

FIG. 2 is a schematic structural view of a power wheel according to a second embodiment of the present invention;

FIG. 3 is a schematic structural view of a power wheel according to a third embodiment of the present invention; and

FIG. 4 is a schematic structural view of a power wheel according to a fourth embodiment of the present invention.

### DETAILED DESCRIPTION OF THE PREFERRED EMBODIMENT

The technical solutions of the present invention are further illustrated in detail with reference to the accompanying drawings and the embodiments.

The power wheel according to the present invention includes a power-driving device and a power supply fixed on the wheel. The power supply is used for supplying power for the power-driving device. The power-driving device is used for driving the wheel to rotate. An example that the power supply is a rechargeable battery and the power-driving device is a motor is taken to illustrate the technical solutions of the power wheel according to the present invention in detail below.

In a main body structure of a power wheel in which the power supply is a rechargeable battery and the power-driving device is a motor according to the present invention, the wheel includes a fixed portion and a rotating portion. The fixed portion includes a wheel spindle and members connected to the wheel spindle. The rotating portion includes an outer ring of the wheel, and the outer ring is connected to the motor shell body. When the power wheel is used, the fixed portion is connected to the frame and the electric bicycle runs through rotation of the rotating portion. In the power wheel according to the present invention, a rechargeable battery is set on the fixed portion or rotating portion of the wheel, and is connected with the motor to supply the motor with electric power to enable rotation of the motor, and the outer ring is driven to rotate by the shell body of the motor, so that the electric bicycle is able to run.

### FIRST EMBODIMENT

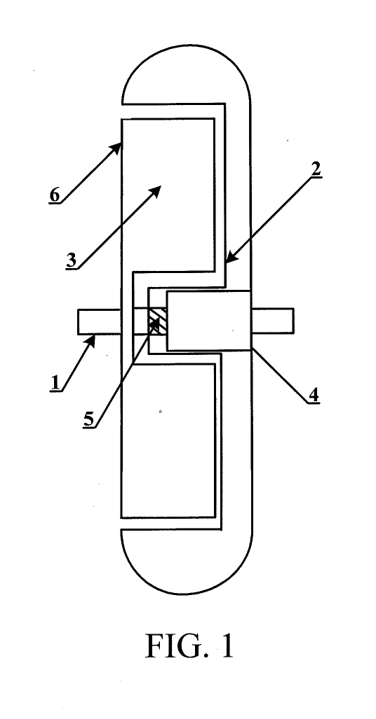

FIG. 1 is a schematic structural view of a power wheel according to a first embodiment of the present invention. As shown in FIG. 1, in this embodiment, the fixed portion includes a wheel spindle 1, a battery case 2 fixedly connected to one side of the wheel spindle 1, a motor 4 fixedly connected to the other side of the wheel spindle 1, and a conductive slip ring 5 fixedly connected to the wheel spindle 1. A rechargeable battery 3 is mounted inside the battery case 2. The motor 4 and the battery case 2 are connected through the conductive slip ring 5 fixedly connected to the wheel spindle 1. When the power wheel rotates, the rechargeable battery 3 is in a static state relative to the wheel spindle 1 and does not rotate together with the outer ring.

The conductive slip ring is a transfer device for realizing signal and current transfer between the two rotation mechanisms, which is especially applicable in a scenario that limitless continuous or intermittent rotation is needed and at the same time power or data further needs to be transmitted from the fixed position to the rotation position. In this embodiment, the motor 4 is connected with the rechargeable battery 3 mounted inside the battery case 2 through the conductive slip ring 5, so that the electric power of the rechargeable battery 3 is conveyed to the motor 4 to provide the electric power for the motor 4.

In this embodiment, the battery box may at least further include a detachable and mountable battery cover 6. The rechargeable battery 3 may be conveniently detached and mounted through the detachable and mountable battery cover 6, so as to greatly facilitate a user to recharge the rechargeable battery after detachment and mount the rechargeable battery after recharge.

In addition, the rechargeable battery may be a lead-acid rechargeable battery, a nickel-hydrogen battery, a nickel-cadmium battery, a lithium ion battery, a polymer lithium battery, a zinc-air battery, a fuel battery or other batteries. A shape of the battery may be designed and produced according to the type demands.

The present invention fully utilizes the space of the wheel, and the power supply device such as the rechargeable battery is set in the wheel, so as to provide the power wheel applicable in the electric bicycle, such that that a body design of the electric bicycle is not influenced by mounting conditions of the rechargeable battery device, a body structure of the electric bicycle is greatly simplified, thus facilitating the design and production of electric bicycles having varied types. At the same time, the power wheel device having the rechargeable battery set in the wheel enables a gravity center of the electric bicycle to be depressed, thus keeping the balance of the electric bicycle.

### SECOND EMBODIMENT

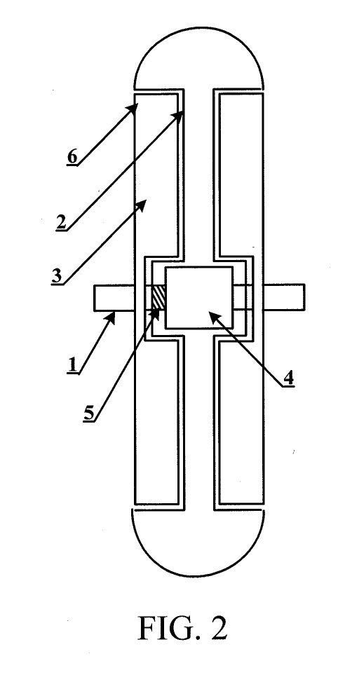

FIG. 2 is a schematic structural view of a power wheel according to a second embodiment of the present invention. As shown in FIG. 2, a difference between the second embodiment and the first embodiment is that in this embodiment, the fixed portion includes a wheel spindle 1, two battery cases 2 fixedly connected to two sides of the wheel spindle 1 respectively, a motor 4 fixedly connected to the wheel spindle 1, and a conductive slip ring 5 fixedly connected to the wheel spindle 1. A rechargeable battery 3 is mounted on each battery case 2. The motor 4 is located between the two battery cases 2. The battery cases 2 are connected through the conductive slip ring 5 fixedly connected to the wheel spindle 1. When the power wheel rotates, the rechargeable batteries 3 are in a static state relative to the wheel spindle 1 and do not rotate with the power wheel.

This embodiment fully utilizes the space of the wheel, the rechargeable battery is set at the fixed portion of the wheel and balance of the electric bicycle is ensured by connecting two battery cases fixedly at two sides of the wheel spindle respectively and mounting the rechargeable batteries in the two battery cases respectively. In addition, the two rechargeable batteries may supply the motor with electric power at the same time, so as to increase the voltage supplied to the motor from the rechargeable battery. On the other hand, one rechargeable battery may also solely supply the motor with electric power and the other rechargeable battery serves as a backup battery, thus providing the backup power supply for the electric bicycle.

### THIRD EMBODIMENT

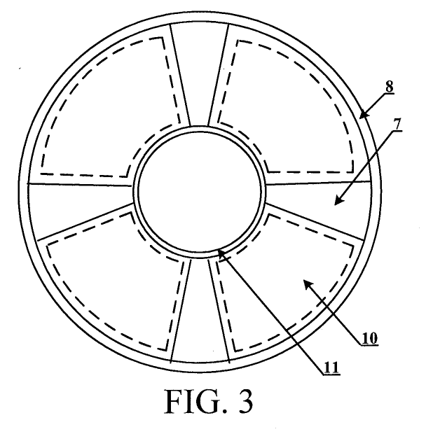

FIG. 3 is a schematic structural view of a power wheel according to a third embodiment of the present invention. As shown in FIG. 3, a different between the third embodiment and the first embodiment is that in this embodiment, the rotating portion includes an outer ring 8 and spokes 7 connected between the outer ring 8 and a shell body 11 of the motor. Rechargeable batteries 3 are fixed among the spokes 7. In addition, ring sector cylindrical battery boxes 10 may further be fixedly connected among the spokes 7, and the rechargeable batteries 3 are mounted on the ring sector cylindrical battery boxes 10.

In this embodiment, a motor 4 is connected with the rechargeable batteries mounted inside the ring sector cylindrical battery boxes 10 through a lead or a conductive slip ring, for conveying the electric power of the rechargeable batteries to the motor 4 so as to supply power for the motor 4. When the power wheel rotates, the rechargeable batteries rotate together with the outer ring 8 under the driven of the shell body 11 of the motor.

In this embodiment, the rechargeable battery is a ring sector cylindrical rechargeable battery, and shapes of the rechargeable battery and battery box may also be designed according to practical demands.

In this embodiment, the ring sector cylindrical battery box may also further include a detachable and mountable battery cover. The rechargeable battery is easily detached and mounted through the detachable and mountable battery cover, so as to greatly facilitate a user to recharge the rechargeable battery after detachment and mount the rechargeable battery after recharge.

In addition, the number of spokes for supporting the outer ring is 4 and a specific number of spokes may also be selected according to the type design demands. At the same time, the member for supporting the outer ring may also be specifically designed as a spoke column or spoke face or members having other shapes according to the type design demands.

This embodiment fully utilizes the space of the wheel, the rechargeable battery is set at the rotating portion of the wheel and a plurality of rechargeable batteries may supply the motor with electric power at the same time by fixedly connecting battery boxes on the wheel spokes respectively and mounting a rechargeable battery on each battery box respectively, so as to increase the voltage supplied from the rechargeable battery to the motor. On the other hand, a certain rechargeable battery may also supply the motor with electric power solely and the rest rechargeable batteries serve as backup batteries, so as to provide backup power supplies for the electric bicycle.

### FOURTH EMBODIMENT

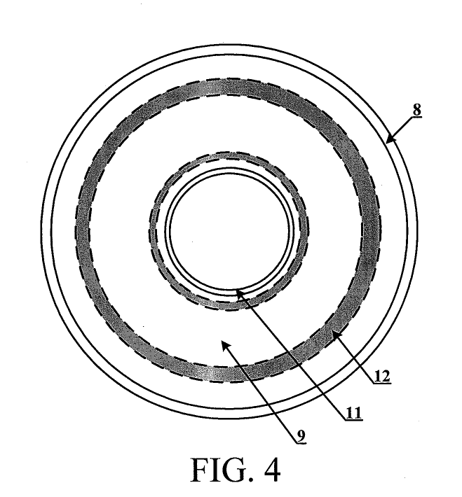

FIG. 4 is a schematic structural view of a power wheel according to a fourth embodiment of the present invention. As shown in FIG. 4, a difference between the fourth embodiment and the third embodiment is that in this embodiment, the rotating portion includes an outer ring 8 and a baffle 9 connected between the outer ring 8 and a shell body 11 of a motor. The rechargeable battery is fixed on the baffle 9.

In order to facilitate mounting of the rechargeable battery, a ring cylindrical battery box 12 may be further set on the baffle 9. A rechargeable battery is fixed inside the ring cylindrical battery box 12, and is connected with the motor through leads to supply the motor with electric power. When the power wheel rotates, the rechargeable battery rotates together with the outer ring 8 under the driven of the shell body 11 of the motor.

In this embodiment, major functions of the baffle include supporting the outer ring and at the same time fixing the battery box in which the rechargeable battery is mounted. By mounting the rechargeable battery in the battery box, anti fouling and waterproofing of the rechargeable battery may further be ensured. Furthermore, the ring cylindrical battery box set on the outer ring may further be designed to include at least one detachable and mountable battery cover, so as to facilitate a user to detach and mount the rechargeable battery.

In this embodiment, the rechargeable battery is a ring cylindrical rechargeable battery, and a shape of the rechargeable battery and battery box may also be designed according to practical demands.

This embodiment fully utilizes the space of the wheel, the rechargeable battery is set at the rotating portion of the power wheel, and a wheel structure is more compact by connecting the shell body of the motor to the outer ring through the baffle. At the same time, the power wheel device having the rechargeable battery set in the wheel enables a gravity center of the electric bicycle to be depressed, thus keeping the balance of the electric bicycle.

Finally, it should be noted that the above embodiments are merely provided for describing the technical solutions of the present invention, but not intended to limit the present invention. It should be understood by persons of ordinary skill in the art that although the present invention has been described in detail with reference to the embodiments, modifications may be made to the technical solutions described in the embodiments, or equivalent replacements may be made to some technical features in the technical solutions, as long as such modifications or replacements do not depart from the spirit and scope of the present invention.

What is claimed is:

1. A power wheel, comprising a wheel, a power-driving device for driving the wheel to rotate, and a power supply for supplying power for the power-driving device, wherein the power supply and the power-driving device are fixed on the wheel.

2. The power wheel according to claim 1, wherein the power supply is a rechargeable battery and the power-driving device is a motor.

3. The power wheel according to claim 2, wherein the wheel comprises a fixed portion formed of a wheel spindle and a member connected to the wheel spindle, and a rotating portion connected to a shell body of the motor, and the rechargeable battery is connected with the motor.

4. The power wheel according to claim 3, wherein the rechargeable battery is fixed at the fixed portion of the wheel, and connected with the motor through a conductive slip ring or a connecting line.

5. The power wheel according to claim 4, wherein the rechargeable battery is fixed at one side or two sides of the wheel spindle.

6. The power wheel according to claim 5, wherein the fixed portion comprises a battery case fixed at one side or two sides of the wheel spindle, and the rechargeable battery is fixed inside the battery case.

7. The power wheel according to claim 3, wherein the rotating portion comprises an outer ring of the wheel and spokes connected between the outer ring and the shell body of the motor, and the rechargeable battery is fixed among the spokes.

8. The power wheel according to claim 7, wherein a battery box is fixed on the spokes, and the rechargeable battery is fixed inside the battery box and connected with the motor through a connecting line or a conductive slip ring.

9. The power wheel according to claim 3, wherein the rotating portion comprises an outer ring of the wheel, and the rechargeable battery is set between the outer ring of the wheel and the shell body of the motor.

10. The power wheel according to claim 9, wherein a battery box is set between the outer ring of the wheel and the shell body of the motor, and the rechargeable battery is fixed inside the battery box and connected with the motor through a connecting line or a conductive slip ring.

11. The power wheel according to claim 2, wherein the rechargeable battery is a ring sector cylindrical rechargeable battery or a ring cylindrical rechargeable battery.

12. The power wheel according to claim 3, wherein the rechargeable battery is a ring sector cylindrical rechargeable battery or a ring cylindrical rechargeable battery.

13. The power wheel according to claim 4, wherein the rechargeable battery is a ring sector cylindrical rechargeable battery or a ring cylindrical rechargeable battery.

14. The power wheel according to claim 5, wherein the rechargeable battery is a ring sector cylindrical rechargeable battery or a ring cylindrical rechargeable battery.

15. The power wheel according to claim 6, wherein the rechargeable battery is a ring sector cylindrical rechargeable battery or a ring cylindrical rechargeable battery.

16. The power wheel according to claim 7, wherein the rechargeable battery is a ring sector cylindrical rechargeable battery or a ring cylindrical rechargeable battery.

17. The power wheel according to claim 8, wherein the rechargeable battery is a ring sector cylindrical rechargeable battery or a ring cylindrical rechargeable battery.

18. The power wheel according to claim 9, wherein the rechargeable battery is a ring sector cylindrical rechargeable battery or a ring cylindrical rechargeable battery.

19. The power wheel according to claim 10, wherein the rechargeable battery is a ring sector cylindrical rechargeable battery or a ring cylindrical rechargeable battery.
